(19) United States
(12) Patent Application Publication
(10) Pub. No.: US 2026/0204020 A1
(43) Pub. Date: Jul. 16, 2026

(54) SYSTEMS AND METHODS FOR MESHED EXECUTION OF USER INTENT WITH DYNAMICALLY CONFIGURED VIRTUAL AGENTS OF A SELF-ORGANIZING VIRTUAL ASSISTANT

(71) Applicant: RingCentral, Inc., Belmont, CA (US)

(72) Inventors: Mostafa Tofighbakhsh, Cupertino, CA (US); Khurram Taji, San Jose, CA (US); Homayoun Razavi, Belmont, CA (US)

(73) Assignee: RingCentral, Inc., Belmont, CA (US)

(21) Appl. No.: 19/018,224

(22) Filed: Jan. 13, 2025

(51) Int. Cl. G06T 17/20; G06T 13/40

(52) U.S. Cl. CPC G06T 17/20; G06T 13/40

(57) ABSTRACT

Disclosed is system and associated methods for a self-organizing virtual assistant that configures and activates different virtual agents for the meshed execution of tasks that are dynamically determined from a stated user intent. The virtual assistant generates actions to implement the user intent, configures a first virtual agent with a first Large Language Model (LLM) that is trained on a first subject matter associated with a first set of actions, and configures a second virtual agent with a second LLM that is trained on a second subject matter associated with a second set of actions. The virtual assistant controls a meshed execution of the actions by activating the virtual agents to perform different sets of actions at different times based on dependencies between the actions and by verifying that executed actions satisfy different thresholds for advancing the user intent.

### TECHNICAL FIELD

The present disclosure relates to the fields of digital virtual assistants and artificial intelligence (AI). The digital virtual assistants and AI are associated with the related technical field of assistive automation.

### BACKGROUND

Virtual personal assistants, like Siri®, Cortana®, and Gemini™, are limited in their usefulness because of the type of tasks they are able to perform. The tasks involve a one-time executed action that provides an immediate response to a user query. For instance, a user may ask for the weather forecast or movie times, and the virtual personal assistant may perform a web query to provide the most relevant answer. Accordingly, the virtual personal assistants are task-specific meaning that they execute the task they are given rather than define their own tasks to fulfill a general objective or intent. Other limitations include the inability of the virtual personal assistants to fully learn from the user. The learning is limited to past interactions that the user has with the virtual personal assistant. For instance, the virtual personal assistant is restricted from accessing private or personal data on the user and/or learning from actions or events that the user performs outside their interactions with the virtual personal assistant.

There is a need for more advanced virtual personal assistants that are objective-based or intent-based and that run continuously to automatically determine, generate, and perform the tasks for an overarching objective or intent that may be unbounded, not have an end result, not produce an immediate result or answer, or require extended execution over hours, days, or months. There is further a need to provide the advanced virtual personal assistant access to private or personal data that is specific to the overarching objective or intent and that is defined outside of interactions that the user has with the advanced virtual personal assistant.

### BRIEF DESCRIPTION OF THE DRAWINGS

FIG. 1 illustrates an example of the dynamic configuration and activation of different virtual agents for the meshed execution of user intent in accordance with some embodiments presented herein.

FIG. 2 illustrates an example architecture of a self-organizing virtual assistive system that performs the meshed execution of user intent with the dynamically configured virtual agents of a self-organizing virtual assistant in accordance with some embodiments presented herein.

FIG. 3 presents a process for effectuating user intent via the meshed execution of the virtual agents in accordance with some embodiments presented herein.

FIG. 4 illustrates an example configuration portal in accordance with some embodiments presented herein.

FIG. 5 illustrates an example of the self-correcting behavior by the self-organizing virtual assistant in accordance with some embodiments presented herein.

FIG. 6 illustrates a specific example of the self-organizing virtual assistant implementing user intent in accordance with some embodiments presented herein.

### DETAILED DESCRIPTION OF PREFERRED EMBODIMENTS

This disclosure arises from the realization that virtual personal assistants that execute on user devices are limited in the functionality that they provide due to each interaction being a one-time prompt-specific operation and the limited private data that is accessible by the virtual personal assistants. While helpful in providing quick answers or executing a simple task in response to a voice command, the virtual personal assistants fall well short of replacing human agents and employees. Human agents or employees perform specialized roles for a business or an individual. The roles involve continuously determining and performing different tasks related to a general mandate that is given to the human agents or employees to carry out. The general mandate may correspond to an unbounded objective or an intent that the human agents or employees implement to the best of their abilities without being told what the individual tasks are to fulfill the objective or the intent.

The current disclosure provides a technical solution for a technological problem in the field of digital or virtual personal assistants and artificial intelligence (AI). The technical solution involves providing a self-organizing virtual assistant that configures and activates different virtual agents for the meshed execution of tasks that are dynamically determined from a stated user intent. The self-organizing virtual assistant assumes the role of a human agent or employee and is able to perform real-world interactions with other humans by autonomously controlling different telephony, video meeting, access control (e.g., door locks), credit card and other payment terminals, point-of-sale, and/or other hardware that is remote or independent of the one or more devices or systems on which the self-organizing virtual assistant executes.

The technical solution involves parsing the user intent to define sets of automated actions that continuously run on different devices or systems and that effectuate a user intent that may be unbounded, not have an end result, not produce an immediate result or answer, or is defined as general mandate or objectives without an enumeration of the tasks for fulfilling that mandate or objectives. Accordingly, the technical solution is differentiable from prior art virtual personal assistants that execute a one-time action in order to provide an immediate response to a user query and then shutdown or wait for the next user query.

The technical solution provides an advanced personalized digital assistant with operations that are not limited to run or control the user device on which the self-organizing virtual assistant executes or to simple tasks that directly respond to a user query. The technical solution implemented through the self-organizing personal assistant involves configuring and activating the different virtual agents to assume the specialized roles of different human agents and dynamically determine and perform complex, non-deterministic, and/or continuous tasks associated with the specialized roles based on a statement of the user intent that does not define the tasks for effectuating the user intent.

The self-organizing virtual assistant configures the different virtual agents with Large Language Models (LLMs) that are specifically trained to emulate a different specialized user role and/or that are trained to specialize in different subject matter. The self-organizing virtual assistant controls the meshed execution of the virtual agents by determining the dependencies between the defined sets of automated actions, and by activating a first virtual agent that performs a first set of automated actions using the output that is generated by a second virtual agent that performs a second set of automated actions when the first set of automated actions is dependent on the output of the second set of automated actions, the first set of automated actions are executed according to the specialized training of a first LLM configured for the first virtual agent, and the second set of automated actions are executed according to the specialized training of a second LLM configured for the second virtual agent. The meshed execution may involve an iterative and dynamic coordination of the virtual agents rather than a static execution loop in which the virtual agents execute the same subsets of actions in the same order. For instance, a first iteration of the meshed execution may include a first virtual agent supplying its output to a second virtual agent based on first triggering events or inputs (e.g., customer calling to schedule an appointment) to the first virtual agent. A second iteration of the mesh execution may include the first virtual agent supplying its output to a third virtual agent based on second triggering events or inputs (e.g., customer calling to change an already scheduled appointment) to the first virtual agent that change the execution flow, change the part of the intent being executed, or cause an objective to be executed in a different manner. In other words, the meshed execution may include a self-organizing formation amongst the virtual agents to effectuate the intent, wherein the self-organizing formation may change depending on inputs received when executing the objectives of the intent or may change until the objectives of the intent are correctly satisfied.

The technical solution involves compiling a statement of user intent into multi-step, dependent, and complex tasks that effectuate the user intent without responding directly to any user question or query, and executing the tasks through the meshed execution of the virtual agents on different devices or systems that have different capabilities and/or that are not limited to capabilities of a single user device. For instance, the self-organizing personal assistant receives a statement of user intent that specifies automating the role of a receptionist, and activates a first set of virtual agents that are specialized for call device automation and for receiving inbound calls related to appointment scheduling, a second set of virtual agents that are specialized for a video display device and for generating personalized greetings of customers at merchant sites through the video display device based on the appointment scheduling, and a third set of virtual agents that are specialized for payment processing devices and for collecting payment after a service has been rendered by controlling the payment processing devices.

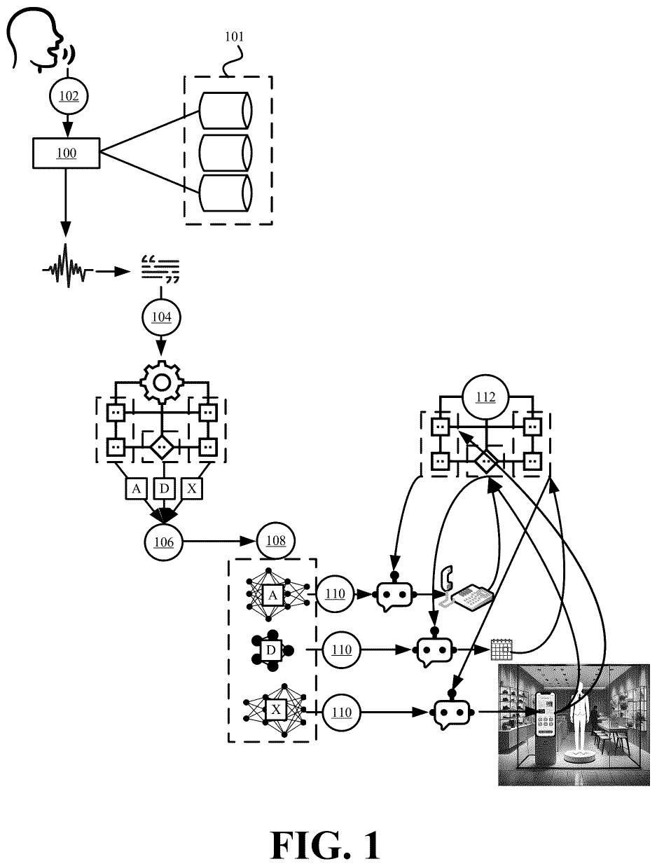

FIG. 1 illustrates an example of the dynamic configuration and activation of different virtual agents for the meshed execution of user intent in accordance with some embodiments presented herein. Self-organizing virtual assistant 100 is initialized (at 102) based on a statement of user intent. In some example embodiments, the user intent statement is one or more audible phrases or sentences spoken by the user that are captured by a microphone and that are forwarded to self-organizing virtual assistant 100. In some other example embodiments, the user intent statement includes text that the user enters using a keyword or other text-entry input interface. The user intent statement is a request for self-organizing virtual assistant 100 to implement one or more objectives that may or may not have a definitive or conclusive ending or end result. The one or more objectives are stated without the intermediary steps or actions by which to implement the one or more objectives or the user intent. Moreover, the user intent statement differs from a query because there is no direct answer or response that immediately completes or fulfills the user intent statement.

Initializing (at 102) self-organizing virtual assistant 100 includes granting self-organizing virtual assistant 100 with access to selected private data of a user. The private data may be stored in one or more different data repositories 101. For instance, user financial data may be stored in a first data store, user health data may be stored in a second data store, user interest or preference data may be stored in a third data store.

Self-organizing virtual assistant 100 compiles (at 104) a set of actions from the stated user intent. Self-organizing virtual assistant 100 may use a speech-to-text transcription tool to transcribe a verbal statement of the user intent. Self-organizing virtual assistant 100 may use a Natural Language Processing (NLP) or other artificial intelligence and/or machine learning (AI/ML) techniques to detect and extract one or more objectives from the user intent and to define and/or determine machine-executable steps or actions that collectively effectuate, implement, or satisfy the one or more objectives. In some example embodiments, AI/ML modeling may be used to define the set of actions that advance an objective past different thresholds. In some other example embodiments, self-organizing virtual assistant 100 uses an agentic AI, the accessible private data, and relevant public data to deductively reduce each objective to a set of actions. In still some other embodiments, self-organizing virtual assistant 100 compiles (at 104) the set of actions through an iterative learning process in which actions are defined to fulfill or satisfy an objective of the user intent, tested against thresholds for advancing through that objective, and refined with modified or new actions until the actions satisfy each of the thresholds for advancing through that objective.

Self-organizing virtual assistant 100 determines (at 106) the subject matter associated with each action of the compiled (at 104) set of actions. For instance, the set of actions may include actions for receiving inbound calls and messages, scheduling employees for services with customers, tracking rendered services for each customer, collecting payment, performing outbound calls and messaging for satisfaction feedback, answering technical support questions, providing product or service demonstration, and/or actions that require other subject matter for proper execution. The actions may be classified according to a predefined list of different subject matter and associations between each subject matter and different actions.

Self-organizing virtual assistant 100 selects (at 108) Large Language Models (LLMs) that are trained on or specialized for the determined (at 106) subject matter. Each LLM is trained to understand and/or parse inputs or tasks associated with a given subject matter and to execute actions that resolve or generate the correct output for the inputs or tasks associated with that given subject matter. For instance, a first LLM may be trained to receive an inbound call and direct the caller to a second LLM based on the caller's requests or answers to questions posed by the first LLM for directing the call. The second LLM may be trained to schedule appointments for different services offered by a particular business by accessing and making correct changes to the calendars of the particular business employees.

Self-organizing virtual assistant 100 configures (at 110) different virtual agents with the selected (at 108) LLMs for execution of the compiled (at 104) set of actions. The virtual agents correspond to autonomous bots or autonomous services that execute actions for a different subject matter based on the subject matter-specific LLM that is selected (at 108) for that different subject matter. Configuring (at 110) the different virtual agents may include connecting one or more of the virtual agents to various devices, hardware, or external systems so that the virtual agents may execute actions that involve controlling the connected devices, hardware, or external systems (e.g., placing outbound phone calls, receiving inbound phone calls, checking-in a user at a merchant terminal, unlocking or providing access to a restricted area, etc.).

Self-organizing virtual assistant 100 controls (at 112) the meshed execution of the virtual agents to effectuate the one or more objectives of the user intent. Controlling (at 112) the meshed execution includes activating the virtual agents to perform different actions of the set of actions in a concerted and/or coordinated manner. Specifically, self-organizing virtual assistant 100 determines the dependencies between the inputs and outputs of the different virtual agents and activates the virtual agents in a correct sequence that feeds the outputs created by a first virtual agent as inputs to a second virtual agent that is dependent on those outputs to implement its subset of actions. Moreover, self-organizing virtual assistant 100 monitors and/or verifies the output created by each virtual agent to ensure that the created output correctly advances the objective or user intent. In response to a virtual agent generating incorrect output that does not advance the user intent past an objective threshold, self-organizing virtual assistant 100 may reconfigure that virtual agent (e.g., select a different LLM, retrain the LLM, or modify input parameters for the LLM) until the virtual agent correctly advances the user intent past the objective threshold.

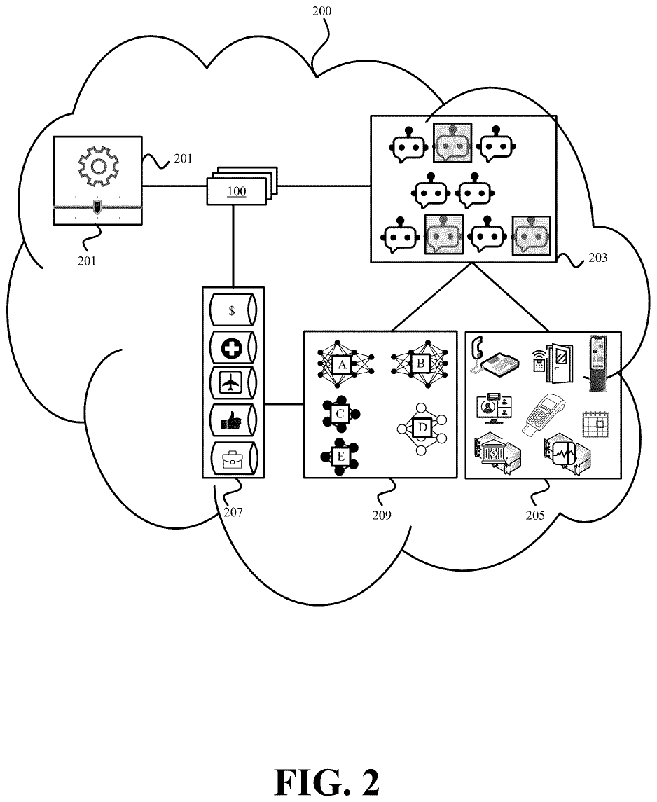

FIG. 2 illustrates an example architecture 200 of a self-organizing virtual assistive system that performs the meshed execution of user intent with the dynamically configured virtual agents of self-organizing virtual assistant 100 in accordance with some embodiments presented herein. Example architecture 200 includes configuration portal 201, different initialized instances of self-organizing virtual assistant 100, virtual agents 203, autonomously controlled devices and systems 205, data stores 207, and LLMs 209. Different embodiments of example architecture 200 may include fewer, more, or combined components. Accordingly, example architecture 200 is provided as one example embodiment for implementing the meshed execution of the user intent.

Example architecture 200 may be executed on one or more distributed devices of a public or shared cloud. In some such example embodiments, self-organizing virtual assistants 100 created by different users may run on the same set of hardware resources. In some other example embodiments, example architecture 200 is executed on a particular user device or a private cloud with hardware resources that are accessible to a particular user or specific set of users.

Configuration portal 201 in an interactive interface with which different users may configure or create different self-organizing virtual assistants 100 to fulfill different user intent. For instance, a user may create a first self-organizing virtual assistant 100 for implementing financial planning objectives specified in a first user intent, and may create a second self-organizing virtual assistant 100 for implementing business objectives specified in a second user intent.

Configuration portal 201 may be used to define a new self-organizing virtual assistant instance 100, provide a name by which the user may call or interact with the self-organizing virtual assistant 100, specify the user intent for the created self-organizing virtual assistant 100, provide the self-organizing virtual assistant 100 access to sets of private user data that are associated with the user intent or that are needed to effectuate the user intent, and/or select LLMs 209 that are trained to perform different actions for the subject matter of the user intent and/or the selected sets of private user data. In some example embodiments, configuration portal 201 includes selectable fields, drag-and-drop functionality, and/or other interactive user interface (UI) elements for defining each self-organizing virtual assistant instance 100. In some other example embodiments, configuration portal 201 defines each self-organizing virtual assistant instance 100 based on code or textual statements.

Each defined self-organizing virtual assistant instance 100 and virtual agents 203 that are initialized, activated, and/or controlled by one of the self-organizing virtual assistants 100 may be stored and run locally from the user device that was used to access configuration portal 201, may be stored and run remotely in the “cloud”, or may be run on the user device and in the cloud. The cloud refers to devices or machines of example architecture 200 that are remotely accessible over a data network. The devices or machines include processor, memory, storage, network, and/or other hardware resources that may be used to execute the different self-organizing virtual assistants 100 and virtual agents 203 created for effectuating different user intent of one or more users.

Self-organizing virtual assistant 100 and virtual agents 203 may correspond to different autonomous bots that continuously execute on behalf of a user to collectively effectuate the user's intent. Each autonomous bot may serve a different specialized purpose and may implement a different part of the user intent.

An autonomous bot may include a virtual agent 203 that executes different subject matter-specific actions and/or controls one or more autonomously controlled devices and systems 205. Autonomously controlled devices 205 include telephony systems for receiving and placing audio calls, video meeting systems, credit card and other payment terminals, points-of-sale devices, video screens and/or speakers for greeting and interacting with humans, physical entry controllers (e.g., door locks and/or other mechanically controlled device of an access system), and/or other hardware. Virtual agents 203 may remotely operate autonomously controlled devices 205 when needed to communicate or interact with humans or when the hardware is needed to execute one or more of the virtual agent actions.

Virtual agents 203 may also execute actions using or through autonomously controlled systems 205. Autonomously controlled systems 205 may include a calendar system, a stock trading system, a banking system, an email system, a text messaging platform, a meeting system, and/or other systems that run on one or more hardware devices that are distinct and remote from the devices on which self-organizing virtual assistant 100 and/or virtual agents 203 execute. For instance, a virtual agent 203 may access a stock trading system on behalf of a user in order to execute trades (e.g., buy and sell stock) autonomously according to the intent of the user. Accordingly, virtual agents 203 may be granted access to control different user services and/or accounts running on different systems and platforms.

The user may interact with configuration portal 201 in order to configure and grant self-organizing virtual assistant 100 and virtual agents 203 access to autonomously controlled devices and systems 205. For instance, the user may enter the network address and access credentials by which a virtual agent 203 may access and control an autonomously controlled device or system 205. Additionally, the user may link to the Application Programming Interface (API) of an autonomously controlled device or system 205, wherein the API includes the list of functions that may be called to cause the autonomously controlled device or system 205 to perform different actions.

Data stores 207 store the private user data and form the user's data lake. Each data store 207 may store a different set of private user data. For instance, a first data store 207 may store the user's financial transactions (e.g., purchase history, stock trades, bill payment, bank account balances, debt obligations, etc.) and a second data store 207 may store the user's daily activities (e.g., morning routine, work schedule and appointments, family obligations, exercise schedule, etc.). The data within data stores 207 may be compiled and/or aggregated by providing self-organizing virtual assistant 100 access to different user accounts or devices where the data may be siloed. The data in data stores 207 may also be obtained from tracking user activities (e.g., geolocation tracking) and/or actions that are performed on one or more user devices. In some example embodiments, the data in data stores 207 is populated by different running instances of self-organizing virtual assistant 100 and/or virtual agents 203.

The private user data stored in data stores 207 may be supplemented with public data that may be queried for and/or obtained from the web, social media sites, and/or publications that are accessible online. The private and public data may be used as inputs to determine the actions that are needed to effectuate the user intent and/or may be used to supplement the actions that are performed by virtual agents 203.

LLMs 209 are neural networks or AI/ML models that are specifically trained on different subject matter. Each LLM 209 is trained to interpret, parse, and process queries, requests, and/or other inputs related to the specific subject matter that the LLM 209 is trained on and to generate correct, accurate, and/or expected output based on actions that are executed in response to the subject matter-specific input. For instance, a first LLM 209 may be trained to schedule appointments and a second LLM 209 may be trained to greet in-store customers. The training of the first LLM 209 may include providing a list of services that may be scheduled, semantically similar references for each service, an amount of time needed for each service, list of employees that provide each service, the availability or calendar of each employee, preferred employees for different customers, services provided to returning customers, service pricing, service frequency (e.g., the time frame between visits or requests for the same service), jargon or specific terminology related to the list of services, speech-to-text service to transcribe audio, and/or data that is specific for appointment scheduling. The first LLM 209 may be trained to generate words and/or audio to obtain necessary information for scheduling an appointment with a desired tone or behaviors, to provide accurate information in response to questions about scheduling or the list of services, to enter appointments on the employee calendars or a business calendar, and/or to provide appointment notifications and confirmations. The training of the second LLM 209 may include providing a list of customer images, names, appointment times, and scheduled services, name pronunciations, desired tone for greetings, desired mannerisms for a virtual greeter, commonly asked questions and answers for a receptionist, jargon or specific terminology related to the list of services, and/or other data that is specific to a receptionist's role. The second LLM 209 may be trained to generate a personalized greeting upon recognizing a scheduled customer, complete questionnaires or information that may be required at the check-in time, notify the correct employee that their customer has arrived, and/or confirm information related to the scheduled appointment. Generating the personalized greeting may include creating a deepfake clone or visual representation of a receptionist, animating the visual representation, and generating audio that is synchronized with the movements and expressions of the visual representation.

Virtual agents 203 may be configured with one or more LLMs 209 in order to comprehend subject matter-specific requests or inputs and perform subject matter-specific actions. Virtual agents 203 may also be configured with access to one or more autonomously controlled devices and systems 205 in order to present the LLM generated content to a user or perform the LLM generated actions.

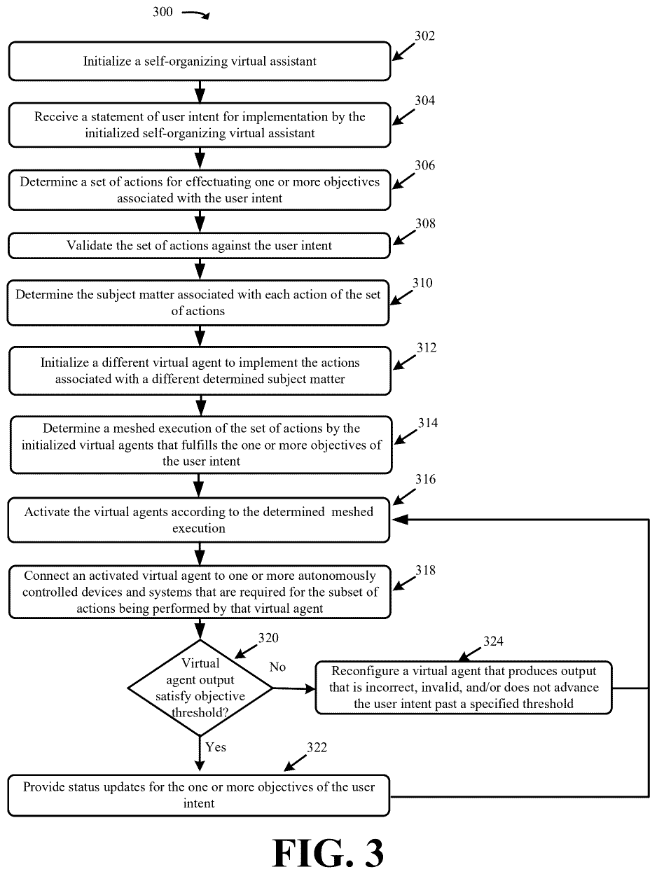

FIG. 3 presents a process 300 for effectuating user intent via the meshed execution of the virtual agents in accordance with some embodiments presented herein. Process 300 is implemented using one or more devices and/or hardware with processor, memory, storage, network, and/or other hardware resources on which example architecture 200 runs.

Process 300 includes initializing (at 302) self-organizing virtual assistant 100 with access to select private and public user data. Initializing (at 302) self-organizing virtual assistant 100 may include creating a new instance of self-organizing virtual assistant 100 in configuration portal 201 and assigning a name with which to reference or call that instance.

Process 300 includes receiving (at 304) a statement of user intent for implementation by the initialized (at 302) self-organizing virtual assistant 100. The statement of user intent may include one or more objectives set forth by the user for the initialized (at 302) self-organizing virtual assistant 100 to fulfill. In some example embodiments, the one or more objectives are expressly stated as part of the user intent, and self-organizing virtual assistant 100 may use NLP and/or AI/ML techniques to extract the objectives. In some other example embodiments, self-organizing virtual assistant 100 may use NLP and/or AI/ML techniques to derive the one or more objectives from the user intent when the objectives are not expressly stated or when the user intent is an overarching goal that is associated with different objectives.

The user intent differs from a query or question that has a direct or immediate answer. There is no direct or immediate answer for the user intent. The user intent also differs from a list of actions or commands as the one or more objectives associated with the user intent omit the actions or commands for effectuating the user intent. The user intent corresponds to a statement of what the user wants without the steps or actions for accomplishing that want.

In some example embodiments, the user intent may be expressed in words that the user speaks into a microphone. In some such example embodiments, the audio is transcribed using a speech-to-text convertor. In some other example embodiments, the user intent may be expressed as written words that the user enters in a file or field of configuration portal 201.

Process 300 includes determining (at 306) a set of actions for effectuating the one or more objectives associated with the user intent. Self-organizing virtual assistant 100 determines (at 306) the set of actions by partitioning each of the one or more objectives into different actionable steps that satisfy different thresholds for advancing that objective and with each actionable step corresponding to a machine-executable action. In some example embodiments, the set of actions may be defined as a JavaScript Object Notation (JSON) file or as calls to different APIs that are specialized for different tasks or operations. In some example embodiments, self-organizing virtual assistant 100 determines a final output associated with an objective and uses AI/ML techniques to work backwards and determine (at 306) the set of actions that produce the final output. For instance, self-organizing virtual assistant 100 may select an action that creates the final output, may determine the input needed for that action, may select another action that generates the needed input as output, and may continue defining and chaining additional actions until the input for the last action is available in a data store or dependent on a user-initiated event or trigger (e.g., calling in, checking-in, requesting an appointment, etc.).

Process 300 includes validating (at 308) the set of actions against the user intent. The validation (at 308) may include verifying that the actions do not violate rules or policies of the user or a business associated with the user. For instance, the user intent may specify automating functions or a role performed by a particular human agent of the business. The particular human agent may perform the functions or actions associated with the role in compliance with policies or rules set for that role. The rules or policies may also safeguard against excessive customer contact (e.g., calling everyday), actions that violate laws or regulations (e.g., disclosing health information, transferring customer payment information, etc.), and/or behaviors or actions that the user or business explicitly prohibits. The validation (at 308) may include presenting the set of actions in a human-readable form to the user via the configuration portal 201, receiving user input or changes, and modifying the set of actions based on the received input or changes. The validation (at 308) may include simulating or testing the set of actions to determine if they satisfy thresholds for advancing the objectives, and modifying any action that fails to advance an objective.

Process 300 includes determining (at 310) the subject matter associated with each action of the determined (at 306) and/or validated (at 308) set of actions. The subject matter may correspond to a technical field, topic, sector, industry, or other classification associated with the action. In some example embodiments, the subject matter is determined (at 310) from the words of the user intent and/or the words that describe an objective of the user intent.

Process 300 includes initializing (at 312) a different virtual agent to implement the actions associated with a different determined (at 310) subject matter. Initializing (at 312) the virtual agent may include creating a new virtual agent instance and configuring the new virtual agent instance with an LLM that is trained on the specific subject matter determined for the actions that will be executed by that new virtual agent instance. In some example embodiments, the selection of the LLM is based on a key-value pair lookup that matches each determined (at 310) subject matter to a different LLM that is specifically trained to parse or decipher inputs relating to specific subject matter and generate subject matter-specific output based on the inputs. In some example embodiments, the user intent is parsed into actionable task verbs or objectives that are then matched against key-value pairs that identify the correct subject matter-specific LLM for that actionable task verb or objective.

Process 300 includes determining (at 314) a meshed execution of the set of actions by the initialized (at 312) virtual agents that fulfills the one or more objectives of the user intent. Self-organizing virtual assistant 100 determines the sequence with which to execute the set of actions based on dependencies between the outputs and inputs of the actions and/or based on an order of execution. Actions without dependencies may be executed in parallel or simultaneously. In some example embodiments, the dependencies are not known beforehand and change as different actions or objectives of the user intent are performed, change based on different inputs being used when executing the actions, and/or change based on different outputs that are produced by each of the virtual agents. Accordingly, self-organizing virtual assistant 100 may determine (at 314) a different meshed execution as the user intent is effectuated rather than repeat a static order-of-execution for different fact patterns or usage scenarios involving the user intent. Moreover, self-organizing virtual assistant 100 may determine (at 314) a different meshed execution until the results of a particular meshed execution effectuate the user intent and/or generate outputs that correctly satisfy different objective thresholds and/or advance the objectives of the user intent. For instance, self-organizing virtual assistant 100 may execute the same usage scenario with different meshed executions of the virtual agents until a particular meshed execution produces results that satisfy the different thresholds associated with each objective of the user intent. Accordingly, determining (at 314) the meshed execution may include dynamically coordinating the virtual agents by continually changing the routing of outputs from a set of virtual agents as inputs to a different set of virtual agents, by continually changing the subset of actions performed by different virtual agents, and/or by continually changing the order of virtual agent execution to adapt the implementation of the single statement of user intent to changing scenarios and fact/input patterns.

Process 300 includes activating (at 316) the virtual agents according to the determined (at 314) meshed execution. Activating (at 316) the virtual agents according to the determined (at 314) meshed execution includes allocating hardware resources from one or more distributed machines when the subset of actions assigned to a particular virtual agent are ready to be executed, and running the initialized (at 312) instance of the particular virtual agent on the allocated hardware resources Accordingly, self-organizing virtual assistant 100 generates and runs the virtual agents at different times as needed up. Activating (at 316) the virtual agents may include routing the outputs produced by one or more virtual agents to inputs of one or more other virtual agents that are dependent on those outputs for action execution.

Process 300 includes connecting (at 318) an activated (at 316) virtual agent to one or more autonomously controlled devices and systems 205 that are required for the subset of actions being performed by that virtual agent. For example, a virtual agent may be initialized to perform a subset of actions associated with scheduling appointments. The subset of actions may involve placing and/or receiving telephone calls and require access to telephony devices or systems in order to place and/or receive the telephone calls. As another example, another virtual agent may be initialized to perform a subset of actions for automatic bill payment such that the virtual agent requires access to a banking system and/or the banking system API by which the virtual agent may execute different bill payment functions. Accordingly, connecting (at 318) the virtual agent may include configuring the virtual agent with access and control of the one or more autonomously controlled devices and systems 205.

To maintain user security and privacy when a virtual agent requires secure login credentials to access and/or control an autonomously controlled device or system 205, self-organizing virtual assistant 100 may compile or encode the secure login credentials into an authentication token that is uniquely linked to the virtual agent and that grants the virtual agent access to the autonomously controlled device or system 205. The virtual agent may use the authentication token in place of the secure login credentials to access and control the autonomously controlled device or system 205. Other private or secure user data may be compiled locally on the device running self-organizing virtual assistant 100 into a token, and the virtual agent may distribute the token off-device.

Process 300 includes determining (at 320) whether the outputs generated by each virtual agent advance the user intent past thresholds set for corresponding objectives. In particular, self-organizing virtual assistant 100 determines whether the actions executed by each virtual agent for a particular intent objective produce output that advances that particular intent objective past various thresholds.

In some example embodiment, the thresholds may correspond to different milestones, goals, or states that track the objective progress and/or track advancement to different objective endpoints. Accordingly, the thresholds may be defined from the user intent and/or the user intent objectives. For instance, an objective may be to schedule appointments. Thresholds associated with that objective include a first threshold for successfully establishing communication with a customer, a second threshold for offering a list of services with descriptions and pricing, and a third threshold for updating employee calendars. Outputs that deviate from or fail to satisfy a threshold are invalid and indicate an action that is incorrectly executed or configured for the advancing the user intent. For instance, output that indicates a customer declining an appointment is verified (at 320) to satisfy the third threshold. However, output that indicates a customer scheduling an unknown service deviates from the conditions of the third threshold and fails the verification (at 320).

In some example embodiments, self-organizing virtual assistant 100 may score the generated virtual agent output against expected or desired output or an objective threshold. In some such example embodiments, self-organizing virtual assistant 100 analyzes the output to determine if the output is within specified ranges, expected values, or follows modeled paths for advancing the objective. The modeled paths may include successful and expected unsuccessful outcomes, conditional branches associated with different objective outcomes, and/or an expected set of outputs leading to a modeled objective outcome. The scores may also correspond to a measure of the similarity or divergence between the output and the thresholds. The scores may be used to determine (at 320) whether the outputs advance the user intent past the objective thresholds. In some example embodiments, the scores determine the percentage of the objective that was implemented or a percentage of the objective that was reached based on the similarity of the output to expected or desired output. Scores or percentages above a specified value (e.g., greater than 70) may indicate that the objective thresholds have been met or satisfied and that the outcome advances the objective towards fulfilling the user intent.

In some example embodiments, the virtual agents are configured to store their output in a shared memory space of self-organizing virtual assistant 100. Self-organizing virtual assistant 100 may track the execution state of the user intent based on the outputs entered into the shared memory, and may determine (at 320) whether the outputs satisfy the thresholds.

Process 300 includes providing (at 322) periodic status updates for the one or more objectives of the user intent in response to verifying (at 320—Yes) that the generated outputs advance the user intent past different thresholds. For instance, self-organizing virtual assistant 100 may generate daily reports of the executed actions, completed tasks, and/or objectives that were fulfilled over the past 24 hours of execution. In some example embodiments, self-organizing virtual assistant 100 notifies the user of certain milestones associated with the user intent or significant activity associated with the user intent (e.g., completed objectives of the user intent).

Process 300 includes reconfiguring (at 324) a particular virtual agent in response to verifying (at 320—No) that the generated outputs are incorrect, invalid, and/or do not advance the user intent past a specified threshold. For instance, the user intent may specify an overall objective that is broken down into smaller objectives by self-organizing virtual assistant 100. The actions performed by the particular virtual agent may generate output that does not advance any of the smaller objectives and/or that cannot be used as input by other virtual agents that are dependent on the particular virtual agent output.

Reconfiguring (at 324) the particular virtual agent may include selecting a different LLM to receive and process inputs to the particular virtual agent and to generate different output that advances the user intent or one or more objectives associated with the user intent. In some example embodiments, reconfiguring (at 324) the particular virtual agent includes modifying the inputs that are provided to the particular virtual agent or retraining the LLM selected for the particular virtual agent so that the generated output is modified to advance the user intent or the one or more objectives associated with the user intent. Reinforcement learning may be used for the LLM retraining. In some such example embodiments, self-organizing virtual assistant 100 presents various outputs of the virtual agents to the user. For instance, self-organizing virtual assistant 100 may present steps by which the virtual agents effectuate the user intent. Self-organizing virtual assistant 100 collects feedback from the user as to the correctness or validity of the steps and/or outputs produced at each step. The user may identify issues or misalignment between the generated output and the user intent, and self-organizing virtual assistant 100 may provide the user feedback as input for the reinforcement learning and/or retraining of the LLM. In some example embodiments, reconfiguring (at 324) the particular virtual agent includes changing the order or time at which the virtual agents are activated during the meshed execution.

Self-organizing virtual assistant 100 reconfigures (at 324) the particular virtual agent in order to adapt the meshed execution to changing scenarios, events, conditions, and/or other variable factors that may affect the implementation and effectuation of the user intent. In other words, reconfiguring (at 324) the particular virtual agent is part of the self-organizing formation of the virtual agents used to dynamically coordinate the execution of actions for advancing the intent past various objective thresholds.

Process 300 continues with the meshed execution and activation (at 316) of the virtual agents until the user stops execution of self-organizing virtual assistant 100 or the user intent is completely implemented. In some example embodiments, the user intent is an open-ended role that self-organizing virtual assistant 100 performs such that there is no definitive or conclusory end to the user intent.

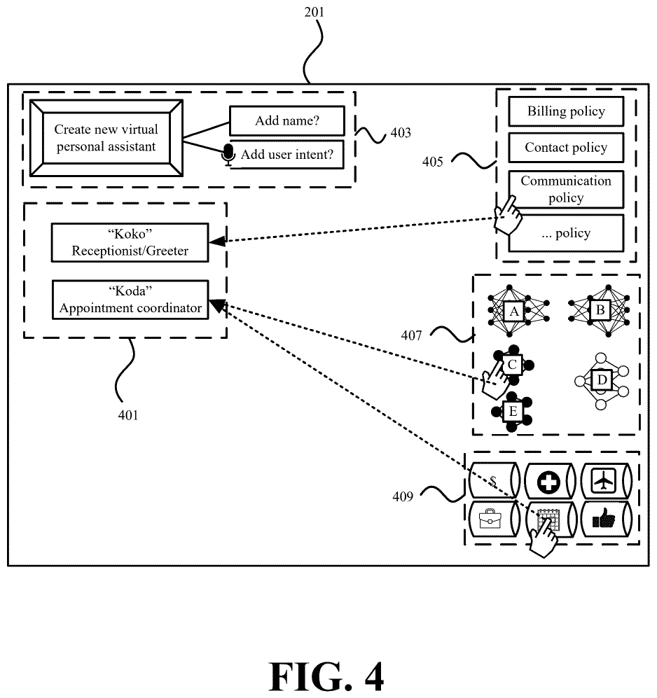

FIG. 4 illustrates an example configuration portal 201 in accordance with some embodiments presented herein. Configuration portal 201 is an interactive graphical user interface (GUI) for defining a self-organizing virtual assistant 100 to perform complex tasks on behalf of a user based on the user's intent.

Configuration portal 201 includes user interface (UI) elements 401 that represent previously defined and running self-organizing virtual assistants 100. The user may select one of UI elements 401 to modify the represented self-organizing virtual assistant 100. For instance, the user may change the name, the user intent, the set of actions that is automatically generated based on the user intent, or individual virtual agents that are controlled by the selected self-organizing virtual assistant 100.

Configuration portal 201 includes fields and/or interactive elements 403 for defining a new self-organizing virtual assistant 100. Fields 403 may be used to name the self-organizing virtual assistant 100. The user may reference the name to verbally select and interact with a specific self-organizing virtual assistant 100 when two or more self-organizing virtual assistants 100 have been defined to implement different user intent. For instance, a user may speak the call command “Hey [virtual assistant name]” on their user device to access the referenced self-organizing virtual assistant 100 and issue further commands such as viewing the activity log or executed actions, modify the user intent, and/or provide feedback for changing the executed set of actions. Fields and/or interactive elements 403 may also be used to provide the user intent that the created self-organizing virtual assistant 100 is to implement.

Configuration portal 201 includes drag-and-drop functionality for associating different policies 405 to the self-organizing virtual assistant 100. Policies 405 provide guardrails that restrict some of the actions that the virtual agents may take or that may be defined for the virtual agents. Policies 405 may be defined according to best practices or modeled practices for different business roles or for different user tasks. For instance, different policies 405 may be set for contacting clients and for billing clients. Policies 405 for contacting clients may prevent the virtual agents from contacting clients during non-business hours, weekends, and holidays and may restrict the contacts to no more than 3 per week if a client does not respond. Policies 405 for billing clients may involve generating and sending a receipt whenever payment is processed, sending invoices at the end of the month, and/or sending reminders for unpaid bills 2 weeks and 1 month after the invoice is sent. By selecting and associating different policies 405 to the self-organizing virtual assistant 100, the user may broadly state their user intent without having to enumerate restrictions and/or guardrails for every action that the virtual agents may take. Policies 405 may be reused and may be automatically modified via AI/ML techniques that monitor responses to the virtual agent actions, behaviors of human agents, and/or based on feedback provided by users.

The drag-and-drop functionality may also be used to select and associate different specialized LLMs 407 to a created instance of self-organizing virtual assistant 100. For instance, a user may select between different LLMs 407 that are specialized to greet customers rather than allow self-organizing virtual assistant 100 to select the preferred LLM.

The drag-and-drop functionality may also be used to grant a created instance of self-organizing virtual assistant 100 access to different private data from the user's private data lake 409. For instance, the user may provide a first instance of self-organizing virtual assistant 100 access to health records when first self-organizing virtual assistant 100 is used to manage the user's healthcare and/or health related appointments, and may provide a second instance of self-organizing virtual assistant 100 access to financial information when second self-organizing virtual assistant 100 is used to trade stocks on behalf of the user.

After creating and defining a self-organizing virtual assistant 100 via configuration portal 201, the user may activate that self-organizing virtual assistant 100. Activating self-organizing virtual assistant 100 includes effectuating the user intent by compiling the user intent into a set of actions, initializing the virtual agents to implement different subsets of the set of actions via LLMs that are specifically trained for the subject matter associated with a different subset of the set of actions, and controlling the meshed execution of the set of actions that satisfy or complete different objectives of the user intent by activating the virtual agents at different times and routing the outputs of one or more virtual agents as input to one or more other virtual agents.

An advantage of self-organizing virtual assistant 100 over existing virtual assistants is the ability of self-organizing virtual assistant 100 to self-diagnose and reconfigure the virtual agents controlled by self-organizing virtual assistant 100 when one or more of the actions performed by the virtual agents fail to satisfy or advance objectives for carrying out the user intent. In other words, self-organizing virtual assistant 100 does not statically define and execute the virtual agents. Instead, self-organizing virtual assistant 100 continually adapts and optimizes the virtual agents to ensure that the piecemeal implementation of the user intent by the virtual agents satisfies different objectives for advancing the user intent past different milestones or thresholds.

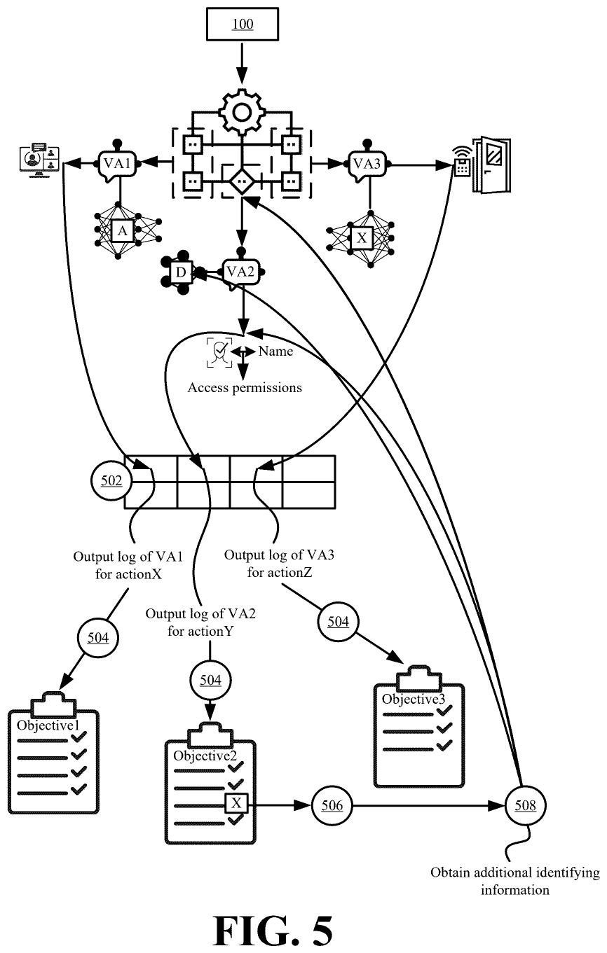

FIG. 5 illustrates an example of the self-correcting behavior by self-organizing virtual assistant 100 in accordance with some embodiments presented herein. Self-organizing virtual assistant 100 compiles the set of actions for effectuating a stated user intent, configures the virtual agents with the specialized LLMs for implementing different subsets of the set of actions, and performs the meshed execution of the user intent by coordinating the activation of the virtual agents.

Self-organizing virtual assistant 100 receives (at 502) the output that is generated by each virtual agent after that virtual agent is activated by self-organizing virtual assistant 100 according to the meshed execution. In some example embodiments, the virtual agents are configured to enter their outputs in a shared memory space of self-organizing virtual assistant 100. Self-organizing virtual assistant 100 may track state and/or progress through the user intent based on the received (at 502) outputs.

Self-organizing virtual assistant 100 analyzes (at 504) the received (at 502) output for advancement of the user intent objectives. The analysis (at 504) may include comparing the received (at 502) output to one or more thresholds that are defined for advancing different objectives or aspects of the user intent. For instance, the user intent may specify providing restricted user access to a facility based on user roles. Self-organizing virtual assistant 100 may define objectives for fulfilling the user intent. The objectives may include greeting and checking-in a user at a main entrance, determining a level-of-access that the checked-in user has, and automatically opening doors that the user has access to when the user is detected to approach those doors. The thresholds may be defined relative to these objectives. For instance, the received (at 502) output may be generated as a result of a first virtual agent performing actions that involve taking a picture of a user, obtaining the user name, and verifying that the user has access to a specific restricted room. Self-organizing virtual assistant 100 may define thresholds for advancing the greeting and check-in objective that include activating a camera upon detecting a person, querying a picture and name database, and querying an access permissions database.

Self-organizing virtual assistant 100 determines (at 506) that the received (at 502) output from a particular virtual agent performing a particular action does not satisfy the one or more thresholds set for the user intent objective associated with that particular action. For instance, the second virtual agent may be unable to match a picture and obtained name to one entry because two employees have the same name.

In response to the received (at 502) output from the particular virtual agent not satisfying the one or more thresholds, self-organizing virtual assistant 100 reconfigures (at 508) the particular virtual agent. Reconfiguring (at 508) the particular virtual agent may include recompiling the subset of actions that the particular virtual agent performs (e.g., changing one or more of the subset of actions), selecting a different specialized LLM for execution of the subset of actions, retraining the selected LLM to resolve the detected error, and/or modifying the execution of the subset of actions (e.g., changing input parameters, policies restricting the execution, etc.). In this example, reconfiguring (at 508) the particular virtual agent includes modifying the matching and/or access permissions lookup to include additional data such as the user's birthdate, employee ID number, and/or other identifying information in addition to the name. Reconfiguring (at 508) the particular virtual agent may also include modifying actions of another virtual agent that greets the user when entering the facility so that the virtual agent requires the customer to provide the additional identifying information when checking-in.

Self-organizing virtual assistant 100 continues reconfiguring (at 508) the virtual agents until the thresholds for advancing the user intent objectives are satisfied in all usage cases or interactions with users. New interactions may present new unaccounted for challenges or unexpected scenarios. For instance, a user may change their appearance or may bring guests with them, and the virtual agent may be unable to grant access because of the changed appearance or the guests. Self-organizing virtual assistant 100 automatically detects which objectives are affected by these new interactions, and automatically modifies the virtual agents executing the actions associated with the advancement of those objectives.

In some example embodiments, self-organizing virtual assistant 100 may be unable to automatically correct for a new interaction that produces output from one or more virtual agents that does not satisfy the thresholds for advancing a user intent objective. In some such example embodiments, self-organizing virtual assistant 100 may notify the user that created self-organizing virtual assistant 100 of the usage scenario. The notification may include various options or modified actions for advancing the user intent objective in view of the usage scenario. The user may select one of the presented options or modified actions, and self-organizing virtual assistant 100 may reconfigure the virtual agents based on the user response. Alternatively, the user may define a new action for the virtual agent to take should that usage scenario reoccur.

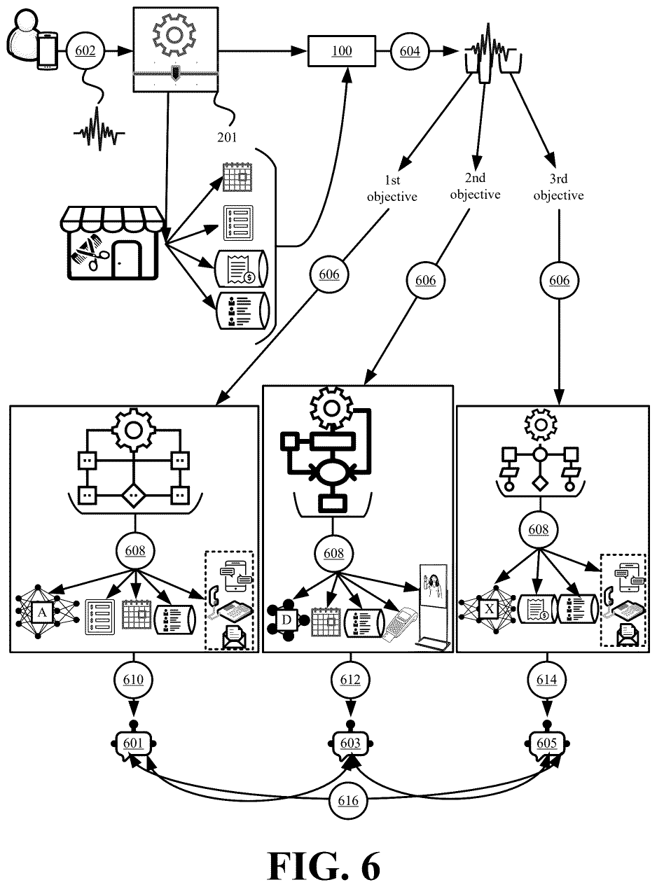

FIG. 6 illustrates a specific example of self-organizing virtual assistant 100 implementing user intent in accordance with some embodiments presented herein. The specific example of FIG. 6 involves a salon owner (i.e., the user) that wants to tailor their business to high value customers that are busy and have limited availability for the salon services. The salon owner determines that the high value customers have a high rate of changing plans at the last minute based on past experience. The salon owner leverages self-organizing virtual assistant 100 to improve the salon's service to these high value customers, increase the salon's rating to attract additional high value customers, and maximize the salon employee workload or utilization.

The salon owner accesses configuration portal 201 to initialize (at 602) a new instance of self-organizing virtual assistant 100 that implements the user's intent for “I want a virtual receptionist that schedules appointments for my salon services to a targeted group of high value customers with basic salon services for men taking 15-20 minutes, with intermediate salon services for men and women taking 30-40 minutes, and with advanced salon services for women taking 1 hour. I want the virtual receptionist to explain the differences between the services to customers, greet customers when they first arrive, bill them at the conclusion of their service, and to follow-up regarding their satisfaction with the provided service.”

As part of initializing (at 602) the new instance of self-organizing virtual assistant 100, access to one or more data stores that contain the pricing and description for each of the salon services, calendars for the work schedule of each employee, payment processing information, list of the targeted group of high value customers, and/or salon policies or best practices for a receptionist role are provided to self-organizing virtual assistant 100. The access may be granted through configuration portal 201 by dragging-and-dropping or otherwise linking the one or more data stores to the new instance of self-organizing virtual assistant 100.

Self-organizing virtual assistant 100 compiles (at 604) the user intent into objectives for appointment scheduling, customer greeting, billing, and customer satisfaction, and defines (at 606) different sets of actions to complete each of the objectives. Self-organizing virtual assistant 100 determines (at 608) one or more autonomously controlled devices or system that are required to complete each of the objectives and the LLMs that are specifically trained on the subject matter associated with each objective.

As shown in FIG. 6, self-organizing virtual assistant 100 generates and configures (at 610) first virtual agent 601 for the first objective of appointment scheduling. Self-organizing virtual assistant 100 configures (at 610) first virtual agent 601 with access to the data for pricing and description for each of the salon services, calendars for the work schedule of each employee, and the list of the targeted group of high value customers. Self-organizing virtual assistant 100 connects first virtual agent 601 to telephony, email, and/or text systems associated with the salon in order to communicate with the customers. Self-organizing virtual assistant 100 configures (at 610) first virtual agent 601 with a first LLM that is trained on the best practices for contacting customers for appointment scheduling including generating audio and/or textual content to describe the services, schedule appointments, and/or addresses customer concerns about the services or appointments (e.g., reschedule, change services, change employee, etc.).

Self-organizing virtual assistant 100 generates and configures (at 612) second virtual agent 603 for the second objective of customer greeting and billing. Self-organizing virtual assistant 100 configures (at 612) second virtual agent 603 with access to the calendars for the work schedule of each employee and/or images of the customers that may be captured from past customer visits or from external data sources. Self-organizing virtual assistant 100 connects second virtual agent 603 to a multimedia interactive display and one or more payment terminals or devices at the salon site. The multimedia interactive display may have a camera to capture images, a microphone to capture sounds, a display to present a visualization or deepfake clone for a digital receptionist, and a speaker to play audio that is synched with the expressions and movements of the digital receptionist. Self-organizing virtual assistant 100 configures (at 612) second virtual agent 603 with a second LLM that is trained on the best practices for the receptionist role and that generates the audio and video for the digital receptionist to identify a customer based on the scheduled appointments made by first virtual agent 601 and/or matching of images captured by the camera to customer images, properly greet the customer, intake any check-in information, provide the customer with any information about their scheduled service, answer any customer questions about the scheduled service, and/or bill the customer via the payment terminal once the service is rendered. Additionally, second virtual agent 603 may be connected to a messaging system so that second virtual agent 603 may notify employees when their customers arrive. For instance, second virtual agent 603 may be connected to a telephony system, may be configured with the mobile telephone numbers of each employee, and may send text messages to the mobile device of an employee when that employee's customer arrives.

Self-organizing virtual assistant 100 generates and configures (at 614) third virtual agent 605 for the third objective of collecting customer satisfaction information. Self-organizing virtual assistant 100 configures (at 616) third virtual agent 605 with access to invoicing data of the salon for rendered services and customer contact information. Self-organizing virtual assistant 100 connects third virtual agent 605 to telephony, email, text message, and/or other communication systems. Self-organizing virtual assistant 100 configures (at 614) third virtual agent 605 with a third LLM that is trained on specific customer satisfaction questions that are important to the salon, review sites that drive business to the salon, and various methods for contacting customers some time after their appointment or service to request the customers to complete the questionnaire and/or to leave a review. In some example embodiments, the third LLM is trained to differentiate between satisfied customer and unsatisfied customers based on tips the customers leave for the employees, customer expressions captured by the camera of the multimedia interactive display when a customer is leaving, and/or other means. In some such example embodiments, the third LLM selectively requests the satisfied customer to complete the questionnaire and/or leave a review on a public site and/or acquires private feedback from the unsatisfied customers. Additionally, the third LLM may be trained to identify customers that have already left reviews or completed a questionnaire and not contact them again, and to identify customers that have left negative reviews or negatively responded to questionnaire, and have a customer service agent follow-up with the dissatisfied customer.

Self-organizing virtual assistant 100 controls (at 616) the meshed execution of virtual agents 601, 603, and 605 to continuously effectuate the objectives of the task. For instance, self-organizing virtual assistant 100 determines that the appointments scheduled by first virtual agent 601 serve as inputs for second virtual agent 603 to identify and greet incoming customers, and that invoices processed by second virtual agent 603 and/or expressions of customers leaving captured by second virtual agent serve as inputs for third virtual agent 605 to initiate outreach for collecting customer satisfaction. Similarly, customer satisfaction results captured by third virtual agent 605 may serve as inputs for first virtual agent 601 in determining a next appointment to schedule, whether to offer a discount on a service, and/or schedule an appointment with the previous employee that serviced the customer or with a new employee.

The embodiments presented above are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the above descriptions are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “updating”, “establishing”, “initiating”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

A “computer” is one or more physical computers, virtual computers, and/or computing devices. As an example, a computer can be one or more server computers, cloud-based computers, cloud-based cluster of computers, virtual machine instances or virtual machine computing elements such as virtual processors, storage and memory, data centers, storage devices, desktop computers, laptop computers, mobile devices, Internet of Things (“IoT”) devices such as home appliances, physical devices, vehicles, and industrial equipment, computer network devices such as gateways, modems, routers, access points, switches, hubs, firewalls, and/or any other special-purpose computing devices. Any reference to “a computer” herein means one or more computers, unless expressly stated otherwise.

The “instructions” are executable instructions and comprise one or more executable files or programs that have been compiled or otherwise built based upon source code prepared in JAVA, C++, OBJECTIVE-C or any other suitable programming environment.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Computer storage media can include volatile and nonvolatile, removable and non-removable media implemented in any method or technology for storage of information such as computer-readable instructions, data structures, program modules, or other data. Computer storage media can include, but is not limited to, random access memory (“RAM”), read only memory (“ROM”), electrically erasable programmable ROM (“EEPROM”), flash memory, or other memory technology, compact disk ROM (“CD-ROM”), digital versatile disks (“DVDs”) or other optical storage, solid state drives, hard drives, hybrid drive, or any other medium that can be used to store the desired information and that can be accessed to retrieve that information.

It is appreciated that the presented systems and methods can be implemented in a variety of architectures and configurations. For example, the systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments. It should be understood, that terms “user” and “participant” have equal meaning in the following description.

1. A computer-implemented method for automated execution of user intent with one or more virtual agents, the computer-implemented method comprising:
initializing a virtual personal assistant based on a statement of the user intent;
generating, by execution of the virtual personal assistant, a plurality of automated actions that implement the user intent in multiple steps;
configuring, by execution of the virtual personal assistant, a first virtual agent with a first Large Language Model (LLM) that is trained on a first subject matter defined as part of a first set of the plurality of automated actions;
configuring, by execution of the virtual personal assistant, a second virtual agent with a second LLM that is trained on a second subject matter defined as part of a second set of plurality of automated actions; and
controlling a meshed execution of the plurality of automated actions with the virtual personal assistant, wherein controlling the meshed execution comprises:
activating, by execution of the virtual personal assistant, the first virtual agent with the first set of automated actions;
executing the first set of automated actions with the first virtual agent controlling operation of a first set of devices or systems;
activating, by execution of the virtual personal assistant, the second virtual agent with the second set of automated actions in response to the virtual personal assistant verifying that output from said executing of the first set of automated actions advances the user intent past a first threshold; and
executing the second set of automated actions with the second virtual agent controlling operation of a different second set of devices or systems.

2. The computer-implemented method of claim 1, further comprising:
receiving the statement of the user intent as audio;
transcribing the audio;
extracting a plurality of objectives for effectuating the user intent from a transcription of the audio; and
wherein generating the plurality of automated actions comprises:
defining the first set of automated actions to satisfy a first objective of the plurality of objectives that is related to the first subject matter; and
defining the second set of automated actions to satisfy a second objective of the plurality of objectives that is related to the second subject matter.

3. The computer-implemented method of claim 1, further comprising:
connecting the first virtual agent to the first set of devices or systems;
configuring the first virtual agent with remote control over the first set of devices or systems;
connecting the second virtual agent to the different second set of devices or systems; and
configuring the second virtual agent with remote control over the different second set of devices or systems.

4. The computer-implemented method of claim 1,
wherein the first set of devices and systems comprises a telephony system; and
wherein activating the first virtual agent comprises one or more of:
answering an inbound telephone call received on the telephony system with the first virtual agent directly interacting with a human caller based on generative output created by the first LLM; and
placing an outbound telephone call through the telephony system with the first virtual agent directly interacting with a human based on generative output created by the first LLM.

5. The computer-implemented method of claim 1, wherein controlling the meshed execution comprises:
determining a dependency between an output that is generated from executing the first set of automated actions with the first virtual agent and an input to the second set of automated actions executed by the second virtual agent;
entering the output that is generated by the first virtual agent into a shared memory of the virtual personal assistant; and
providing the output from the shared memory as the input to the second set of automated actions executed by the second virtual agent.

6. The computer-implemented method of claim 1,
wherein executing the first set of automated actions with the first virtual agent comprises scheduling appointments with a plurality of customers; and
wherein executing the second set of automated actions comprises generating a virtual receptionist on a display at a merchant site that provides a customized greeting to each customer of the plurality of customers based on the appointments scheduled by the first virtual agent.

7. The computer-implemented method of claim 1, further comprising:
detecting a first objective that is directed to the first subject matter and a second objective that is directed to the second subject matter in the user intent;
selecting, for the first virtual agent, the first LLM from a plurality of LLMs that are trained on different subject matter based on the first subject matter that the first LLM is trained on matching the first subject matter of the first objective; and
selecting, for the second virtual agent, the second LLM from the plurality of LLMs based on the second subject matter that the second LLM is trained on matching the second subject matter of the second objective.

8. The computer-implemented method of claim 1, further comprising:
defining a plurality of thresholds that verify advancement of the user intent based on wording of the user intent; and
associating different thresholds from the plurality of thresholds to output of different actions from the plurality of automated actions.

9. The computer-implemented method of claim 1,
wherein activating the first virtual agent comprises allocating resources to the first virtual agent and running the first virtual agent using the resources at a first time; and
wherein activating the second virtual agent comprises allocating different resources to the second virtual agent and running the second virtual agent using the different resources at a second time that is after the first time.

10. The computer-implemented method of claim 1, further comprising:
providing a configuration portal with a plurality of interactive user interface elements; and
granting the virtual personal assistant to specific private data from different data stores based on a user interaction with a user interface elements representing the virtual personal assistant and one or more user interface elements representing the specific private data in the configuration portal.

11. The computer-implemented method of claim 1, further comprising:
determining that the output from said executing of the first set of automated actions does not advance the user intent past the first threshold;
reconfiguring the first virtual agent in response to determining that the output does not advance the user intent past the first threshold; and
executing a different third set of automated actions with the first virtual agent after said reconfiguring that generates different output for advancing the user intent past the first threshold.

12. The computer-implemented method of claim 1, further comprising:
determining that the output from said executing of the first set of automated actions does not advance the user intent past the first threshold;
configuring the first virtual agent with a third LLM in response to determining that the output does not advance the user intent past the first threshold; and
executing the first set of automated actions based on output generated by the third LLM that advances the user intent past the first threshold.

13. The computer-implemented method of claim 12, wherein configuring the first virtual agent with the third LLM comprises:
retraining the first LLM to produce modified output that advances the user intent past the first threshold in response to executing the first set of automated actions.

14. A self-organizing system for automated execution of user intent, the self-organizing system comprising:
one or more hardware processors configured to:
initialize a virtual personal assistant based on a statement of the user intent;
generate, by execution of the virtual personal assistant, a plurality of automated actions that implement the user intent in multiple steps;
configure, by execution of the virtual personal assistant, a first virtual agent with a first Large Language Model (LLM) that is trained on a first subject matter defined as part of a first set of the plurality of automated actions;
configure, by execution of the virtual personal assistant, a second virtual agent with a second LLM that is trained on a second subject matter defined as part of a second set of plurality of automated actions; and
control a meshed execution of the plurality of automated actions with the virtual personal assistant, wherein controlling the meshed execution comprises:
activate, by execution of the virtual personal assistant, the first virtual agent with the first set of automated actions;
execute the first set of automated actions with the first virtual agent controlling operation of a first set of devices or systems;
activate, by execution of the virtual personal assistant, the second virtual agent with the second set of automated actions in response to the virtual personal assistant verifying that output from said executing of the first set of automated actions advances the user intent past a first threshold; and
execute the second set of automated actions with the second virtual agent controlling operation of a different second set of devices or systems.

15. The self-organizing system of claim 14, wherein the one or more hardware processors are further configured to:
receiving the statement of the user intent as audio;
transcribing the audio;
extracting a plurality of objectives for effectuating the user intent from a transcription of the audio; and
wherein generating the plurality of automated actions comprises:
defining the first set of automated actions to satisfy a first objective of the plurality of objectives that is related to the first subject matter; and
defining the second set of automated actions to satisfy a second objective of the plurality of objectives that is related to the second subject matter.

16. The self-organizing system of claim 14, wherein the one or more hardware processors are further configured to:
connecting the first virtual agent to the first set of devices or systems;
configuring the first virtual agent with remote control over the first set of devices or systems;
connecting the second virtual agent to the different second set of devices or systems; and
configuring the second virtual agent with remote control over the different second set of devices or systems.

17. The self-organizing system of claim 14,
wherein the first set of devices and systems comprises a telephony system; and
wherein activating the first virtual agent comprises one or more of:
answering an inbound telephone call received on the telephony system with the first virtual agent directly interacting with a human caller based on generative output created by the first LLM; and
placing an outbound telephone call through the telephony system with the first virtual agent directly interacting with a human based on generative output created by the first LLM.

18. The self-organizing system of claim 14, wherein controlling the meshed execution comprises:
determining a dependency between an output that is generated from executing the first set of automated actions with the first virtual agent and an input to the second set of automated actions executed by the second virtual agent;
entering the output that is generated by the first virtual agent into a shared memory of the virtual personal assistant; and
providing the output from the shared memory as the input to the second set of automated actions executed by the second virtual agent.

19. The self-organizing system of claim 14,
wherein executing the first set of automated actions with the first virtual agent comprises scheduling appointments with a plurality of customers; and
wherein executing the second set of automated actions comprises generating a virtual receptionist on a display at a merchant site that provides a customized greeting to each customer of the plurality of customers based on the appointments scheduled by the first virtual agent.

20. A non-transitory computer-readable medium storing program instructions that, when executed by one or more hardware processors of a self-organizing system for automated execution of user intent, cause the self-organizing system to perform operations comprising:
initializing a virtual personal assistant based on a statement of the user intent;
generating, by execution of the virtual personal assistant, a plurality of automated actions that implement the user intent in multiple steps;
configuring, by execution of the virtual personal assistant, a first virtual agent with a first Large Language Model (LLM) that is trained on a first subject matter defined as part of a first set of the plurality of automated actions;
configuring, by execution of the virtual personal assistant, a second virtual agent with a second LLM that is trained on a second subject matter defined as part of a second set of plurality of automated actions; and
controlling a meshed execution of the plurality of automated actions with the virtual personal assistant, wherein controlling the meshed execution comprises:
activating, by execution of the virtual personal assistant, the first virtual agent with the first set of automated actions;
executing the first set of automated actions with the first virtual agent controlling operation of a first set of devices or systems;
activating, by execution of the virtual personal assistant, the second virtual agent with the second set of automated actions in response to the virtual personal assistant verifying that output from said executing of the first set of automated actions advances the user intent past a first threshold; and
executing the second set of automated actions with the second virtual agent controlling operation of a different second set of devices or systems.
